(19) United States
(12) Patent Application Publication
(10) Pub. No.: US 2012/0087962 A1
(43) Pub. Date: Apr. 12, 2012

(54) NOVEL ARTICLE

(76) Inventors: Kimberly Biedermann, Parsippany, NJ (US); Philip Oths, Parsippany, NJ (US)

(21) Appl. No.: 13/376,989

(22) PCT Filed: Jun. 10, 2010
(86) PCT No.: PCT/US10/38073

§ 371 Date: Dec. 8, 2011

Related U.S. Application Data
(60) Provisional application No. 61/185,869, filed on Jun. 10, 2009.

(51) Int. Cl. A01N 25/08; A01N 25/10; B05D 3/02; A01N 1/00

(52) U.S. Cl. 424/402; 424/400; 427/2.31

(57) ABSTRACT

Aspects of the present invention are directed to personal protection articles, such as protective clothing, articles for sequential contact with multiple users, and cellulosic articles, which have their surface a coating formulation having activity to de-activate pathogenic micro-organisms, the coating comprising an acidic polymer, suitably the polymaleic acid material Gantrez™, a surfactant and an acid. Processes for making such articles, and suitable coating formulations are also disclosed.

This invention relates to novel articles, being articles coated with anti-microbial coatings to reduce the risk of cross-contamination and/or infection by harmful pathogenic micro-organisms. This invention also relates to process for depositing such coatings, and to formulations for use in such processes.

In the past century three pandemics of Influenza have been witnessed, of which the “Spanish flu” of 1918 was the largest pandemic of any infectious disease known to medical science (Oxford, J. S., 2000). The three strains which caused these pandemics belong to group A of the influenza virus and, unlike the other two groups (B and C), this group infects a vast variety of animals (poultry, swine, horses, humans and other mammals). Influenza A virus continue to cause global problems, both economically and medically (Hayden, F. G. & Palese, P., 2000). A current global concern is the Avian Influenza A H5N1 virus, which first demonstrated its ability to infect birds in China in 1997 and has since spread to other countries in South East Asia, Europe and Africa (Enserink, M, 2006: Guan, Y. et al., 2004; Peiris, J. S. et al., 2004). Its ability to cause severe disease in birds was documented by the World Health Organisation during a mild outbreak in South East Asian birds during 2003-2004. H5N1 mutates rapidly and is highly pathogenic. Its co-existence with other avian influenza virus increases the likelihood of concurrent infections in birds. Such events would provide the ‘mixing vessel’ for the emergence of a novel subtype with sufficient avian genes to be easily transmitted between avian species, which would mark the start of an influenza epidemic (WHO Fact sheet). A more recent potential influenza pandemic strain is the H1N1 so called “Swine Flu”.

Much has been done to control and prevent another pandemic from occurring with many anti-influenza products (vaccines and treatments) currently on the market. Presently, Amantadine is the principal antiviral compound against Influenza infections, but its activity is restricted to Influenza A virus. Anti-neuraminidase inhibitors, such as Zanamivir (Relenza) and Oseltamivir (Tamiflu), are a new class of antiviral agents licensed for use in the treatment of both Influenza A and B infections (Carr, J., et al., 2002). The role of these antivirals in a pandemic may be limited due to the time and cost involved in production and the current limited supply. With the recent news of a probable H5N1 pandemic the need to prevent any opportunities of transmission of the virus between avian species has risen.

At the present time the risk of infection by the so called “bird flu” H5N1 virus or “swine flu” H1N1 virus is of particular concern. The inhalation of air contaminated by harmful virus and/or other micro-organisms is a common route for infection of human beings, particularly health workers and others caused to work with infected humans or animals. Air exhaled by infected patients is a source of contamination. Applicant's WO-A-2008/009651 discloses a face mask comprising an air permeable fibrous substrate treated with a coating having anti-viral activity and comprising an acidic polymer.

Air filters believed to remove such virus and/or other micro-organisms are known. One type of such a filter comprises a fibrous or particulate substrate on which is deposited, upon the surface and/or into the bulk of such fibres or particles, a substance which captures and/or neutralises virus and/or other micro-organisms of concern. Examples of disclosures of such filters are listed below.

U.S. Pat. No. 3,871,950 and U.S. Pat. No. 4,181,694 disclose hollow fibres of acrylonitrile polymers for ultrafilter use, primarily for filtering aqueous media. U.S. Pat. No. 4,856,509 discloses a face mask wherein select portions of the mask contain a viral destroying agent such as citric acid. U.S. Pat. No. 5,767,167 discloses aerogel foams suited for filtering media for capture of micro organisms such as virus etc. U.S. Pat. No. 5,783,502 discloses a fabric substrate with anti viral molecules, particularly cationic groups such as quaternary ammonium cationic hydrocarbon groups bonded to the fabric. U.S. Pat. No. 5,851,395 discloses a virus filter comprising a filter material onto which is deposited a virus-capturing material based on sialic acid (9-carbon monosaccharides having a carboxylic acid substituent on the ring). U.S. Pat. No. 6,182,659 discloses a virus-removing filter based on a Streptococcus agalactiae culture product. U.S. Pat. No. 6,190,437 discloses an air filter for removing virus from the air comprising a carrier substrate impregnated with “iodine resins”. U.S. Pat. No. 6,379,794 discloses filters based on glass and other high modulus fibres impregnated with an acrylic latex. U.S. Pat. No. 6,551,608 discloses a porous thermoplastic material substrate and an antiviral substance made by sintering at least one antiviral agent with the thermoplastic substance. U.S. Pat. No. 7,029,516 discloses a filter system for removing particles from a fluid comprising a non-woven polypropylene base upon which is deposited an acidic polymer such as polyacrylic acid. US-A-2004/0250683 discloses a filter material comprising a network of fibres with an acidic substance deposited thereon, which may be an acrylic polymer. US-A-2005/0247608 discloses a filter block which may be treated with various anti viral polymers, principally cationic polymers.

WO-A-2001/07090 discloses a filter for removing micro-organisms comprising a substrate having a reactive surface and a polymer on its surface which includes cationic groups for attracting micro organisms. WO-A-2002/058812 discloses an air filter with micro-encapsulated biocides. WO-A-2003/039713 discloses a filter material said to have an anti pathogenic effect, including an effect against virus, based on a fibrous substrate partly coated with a polymer network containing pendant functional groups which may be acidic groups. WO-A-2005/070242 discloses an inhalation filter made of fibres treated to impart an electrical charge to catch particles such as virus.

GB-A-2035133 discloses a membrane filter with a water-insoluble polymer, preferably a PVA, on its surface. Use of such a filter material in gas mask cartridges is suggested.

JP-A-2001/162116 discloses an antibacterial filtration medium in which a self-cross-linking acrylic resin is used to bind a silver-organic iodine antibacterial agent to a fibrous substrate. JP-A-2005/198676 discloses the use of a water-hardenable resin emulsion to bind citric acid to an antiviral face mask.

Three papers in Journal of Virology: September 1968, p 878-885; March 1970, p 313-320 and p 321-328, disclose antiviral activity of various polycarboxylic acids including polyacrylic acid, polymethacrylic acid and polyacetal carboxylic acids. The antiviral activity reported therein appears to be a cell-mediated effect, and the conclusion is expressed that “PMAA (polymethacrylic acid) did not inactivate the virus particle in its extracellular state”.

In addition to such air filters there is an ongoing need to address the problem of preventing cross-contamination and infection by harmful micro-organisms via other means, for example other environments and via infected articles handed from one person to another. It is an object of the present invention to at least in part to address this problem by means of the provision of articles coated with anti-microbial coatings, process for depositing such coatings, and to formulations for use in such processes disclosed herein. The present inventors have unexpectedly discovered that certain acidic polymers provide antiviral activity in a wide variety of applications, and at least in part provide a solution to the problem of combating viral infection.

According to a first aspect of this invention a personal protection barrier article is provided comprising a barrier layer which is substantially impermeable to water and/or air, and which is adapted to provide a physical barrier between a human body and an undesirable contact, the barrier layer having on its surface a coating formulation having activity to de-activate pathogenic micro-organisms, the coating comprising an acidic polymer, a surfactant and an acid.

Examples of materials from which such a barrier layer can be made include soft and rigid plastics materials, elastomers such as synthetic and natural rubbers, glass and metals.

Examples of barrier articles include human body clothing, head coverings including soft elasticated hair coverings, such as impermeable clothing e.g. for healthcare workers or military personnel, helmets, eye coverings such as spectacles and goggles, gloves such as rubber gloves, protective shielding equipment, shoes, boots, children's bootees, diapers, condoms, body bags and other containers for corpses.

Barrier articles of this aspect of the invention may for example find use in the following fields. Protecting medical or para-medical personnel, for example in hospital environments or in the field, for example whilst working with infected or contaminated persons, for example during an epidemic or pandemic. Protecting carers, such as parents or those with caring responsibilities for infected or contaminated persons. Protecting military personnel, for example in the event that they need to enter areas contaminated with pathogenic micro-organisms, for example during a biological warfare scenario or if providing assistance during an epidemic or pandemic. Protecting those working with or caring for small children. Protecting those engaged in sexual activity with other than trusted partners. Protecting those involved with transporting and disposing of dead bodies.

The invention also provides a process for making such a personal protection barrier article, in which process the surface of the material of the barrier layer is contacted with a fluid loading solution comprising the acidic polymer, the surfactant and the acid in a liquid vehicle, and causing the liquid vehicle to evaporate to thereby deposit the coating formulation. Such a process may be performed either prior to or after incorporating the barrier layer into the barrier article.

According to another aspect of this invention an article of personal clothing is provided comprising a layer of a fabric, the fabric having deposited on its surface a coating formulation having activity to de-activate pathogenic micro-organisms, the coating comprising an acidic polymer, a surfactant and an acid.

Examples of fabrics from which such an article of clothing can be made include cotton, rayon, nylon, polyester and fabrics conventionally used for clothing, and such fabrics may be permeable to air, or both air and water, or may be permeable to air but not water.

Such clothing may be adapted to fit the upper and/or lower torso of the wearer, and/or the wearer's arms, legs, hands and feet. Examples of such clothing include underwear, overwear, leg wear, coats and headgear. Examples of such clothing include healthcare workers', e.g. physicians', nurses' etc. uniforms and other clothing. Advantageously such clothing may comprise conventional commercially available clothing upon which the coating formulation is deposited, and being visually indistinguishable from conventional clothing.

Suitably the fabric may comprise the outer layer of such clothing. The outer layer of clothing is normally the layer with which initial contact of the wearer with a contaminated environment occurs, and providing the fabric as the outer layer can help to neutralize any pathogen which contacts the surface.

Clothing of this aspect of the invention may for example find use in the following fields. Protecting wearers for example in environments where they anticipate contact or close association with infected or contaminated persons, for example during a pandemic or whilst working with infected or contaminated persons. Protecting carers, such as parents or those with caring responsibilities for infected or contaminated persons. Protecting personnel, for example in the event that they need to enter areas contaminated with pathogenic micro-organisms, for example if providing assistance during an epidemic or pandemic. Protecting those working with or caring for small children. Protecting those involved with handling or disposing of corpses.

The invention also provides a process for making such an article of clothing, in which process the surface of the fabric is contacted with a fluid loading solution comprising the acidic polymer, the surfactant and the acid in a liquid vehicle, and causing the liquid vehicle to evaporate to thereby deposit the coating formulation. Such a process may be performed either prior to or after incorporating the fabric into the article of clothing.

According to another aspect of this invention an article intended for sequential handling by multiple persons at least one of whom may be potentially contaminated by pathogenic micro-organisms is provided, having on its surface a coating formulation having activity to de-activate pathogenic micro-organisms, the coating comprising an acidic polymer, a surfactant and an acid.

By “article intended for sequential handling by multiple persons” is meant an article intended for commonplace use, contact, handling or exchange by multiple persons. Such contact, handling or exchange may for example occur by means of the article itself being transferred from person to person, or by means of multiple persons sequentially coming into contact with the article.

Examples of such articles include mail envelopes and mail wrapping materials such as wrapping paper and bubble wrap, public seats such as in public buildings, buses, trains, taxicabs, aircraft, boats and ships, hotels, hospitals and physician's surgeries, money (paper and coins), books and CD's available in public libraries, children's toys, culinary articles such as work surfaces, cutting boards and cheese boards e.g. in restaurants, food outlets, supermarkets and food stores; telephones such as public telephones and fixed office telephones, keypads, pens for public use such as the tied-down pens in banks, public offices etc., light switches, door handles, railings, elevator controls, bathroom surfaces, shower curtains, toilet seats, water taps, bathtubs, shower cubicles and sinks in public washrooms such as hotels, airports, train stations, passenger ships, aircraft, gym equipment such as exercise machines, weights, exercise balls, multiple use linen such as hotel bedding, towels etc.

Articles of this aspect of the invention may for example find use in all forms of daily activity and public life. They may protect those using them during an epidemic or pandemic in the event of previous contact with, handling or use by a person infected or contaminated by a pathogenic micro-organism.

The invention also provides a process for making such an article in which a coating having activity to de-activate pathogenic micro-organisms is deposited upon an article intended for sequential handling by multiple persons, the coating comprising an acidic polymer, a surfactant and the acid, by contacting the surface of the article with a fluid loading solution comprising the acidic polymer, the surfactant and the acid in a liquid vehicle, and causing the liquid vehicle to evaporate.

According to another aspect of this invention a personal care article is provided, comprising an absorbent cellulosic, e.g. paper substrate impregnated with an impregnation formulation having activity to de-activate pathogenic micro-organisms, the coating comprising an acidic polymer, a surfactant and an acid.

Examples of such personal articles include paper towels, toilet paper, hand, face and body wipes such as baby wipes, etc. The formulation may be a dry formulation or a wet formulation, e.g. with the acidic polymer, surfactant and acid dissolved or suspended in a liquid vehicle.

Articles of this aspect of the invention may for example find use in all forms of personal hygiene and healthcare. They may protect those using them during an epidemic or pandemic in the event of previous contact with, handling or use by a person infected or contaminated by a pathogenic micro-organism.

The invention also provides a process in which a formulation having activity to de-activate pathogenic micro-organisms is impregnated onto a personal care article comprising an absorbent paper substrate, the formulation having activity to de-activate pathogenic micro-organisms, the impregnation formulation comprising an acidic polymer, a surfactant and an acid.

It has been found that acidic polymers are effective at capturing and neutralising virus contacting such a coating. Without being limited to a specific theory of action it is believed that upon contact with the coating the virus interacts with the polymer, is entrapped and the localised low pH environment (e.g. ca. pH 2.8 to 5) of the acidic polymer inactivates the virus to thereby neutralise them. It is believed that the coatings of this invention may be effective in this manner against the virus that cause colds, influenza, SARS, RSV, bird flu and mutated serotypes of these.

As used herein the term “acidic polymer” includes a polymer having acidic groups along its backbone, e.g. as side groups. Suitable acidic groups are carboxylic acid groups. The acidic polymer may be cross-linked or linear. Generally for the present application non-cross linked, e.g. linear polymers are preferred. This is inter alia because relative to cross-linked polymers non-cross linked linear structure can provide more available —COOH groups, and also non-cross linked polymers are easier to dissolve and consequently to use in the preparative process disclosed herein.

The acidic polymer may comprise a poly-(carboxylic acid) polymer.

Poly-(carboxylic acid) polymers are typically polymers which include —COOH groups in their structure, or derivative groups such as acid-anhydride groups, readily cleavable carboxylic acid ester groups or salified —COOH groups which readily cleave to yield —COOH groups.

A poly-(carboxylic acid) polymer may have its —COOH groups (or derivative groups) directly linked to its backbone, or the polymer may be a so-called grafted or dendritic polymers in which the —COOH (or derivative) groups are attached to side chains branching off from the backbone.

For example poly-(carboxylic acid) polymers may include:

—[—CR¹.COOH—]—

units in their structure, wherein R¹ is preferably hydrogen, or R¹ may be C₁₋₃ alkyl, C₁₋₃ alkoxy or C₁₋₃ hydroxy alkyl.

One type of such a poly-(carboxylic acid) polymer comprises a polymer having units:

—[—CR²R³—CR¹.COOH—]—

in its structure wherein R² and R³ are independently preferably hydrogen, or may be C₁₋₃ alkyl or C₁₋₃ alkoxy. For example such a polymer may comprise a poly-(carboxyvinyl) polymer, for example a polymer of a monomer compound of formula CR²R³═CR¹.COOH wherein the substituents are as defined above. Such a polymer may comprise a polymer of acrylic acid or methacrylic acid, i.e. polyacrylic or polymethacrylic acid, e.g. linear polyacrylic and polymethacrylic acid homo- and co-polymers. An example of such a polymer is carboxypolymethylene. An example of a commercially available polyacrylic acid is the material Good-Rite™ K-702 which has a molecular weight of around 30,000. An example of a commercially available polyacrylic acid, as its sodium salt, is the material Good-Rite™ K-765 which also has a molecular weight of around 30,000. Polyacrylic acid polymers are commercially available under the trade name Carbomer™ classified as a synthetic polymer and is otherwise used as an emulsion stabilizer as well as an aqueous viscosity-increasing agent.

Polymers of this type are for example disclosed in U.S. Pat. No. 2,798,053 viz “a carboxylic monomer such as acrylic acid, maleic acid or anhydride and the like, copolymerized with certain proportions of a polyalkenyl polyether of a polyhydric alcohol containing more than one alkenyl ether grouping per molecule, the parent polyhydric alcohol containing at least 4 carbon atoms and at least three hydroxyl groups.”

Examples of cross-linked poly-(carboxylic acid) polymers include homopolymers of acrylic acid crosslinked with an allyl ether, e.g. of pentaerythritol, of sucrose or of propylene, e.g. the material available from B.F. Goodrich Company under the trade name “Carbopol”, such as the specific Carbopols include Carbopol 934, 940, 980, 1382, Carbopol ETD 2020, ETD 2050, Ultrez 20 and 21.

Another type of such a poly-(carboxylic acid) polymer may include adjacent

—[—CR¹.COOH—]—

units (where R¹ is defined above) in its structure, for example polymers based on maleic acid moieties which typically include —[—CH.COOH—CH.COOH—]— units, and/or salts or esters of such units, or such units in anhydride form in which COOH groups on adjacent carbon atoms may be cyclised to form a

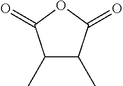

ring system, such derivatives being susceptible to hydrolysis to form the corresponding free acid.

One type of such a poly-(carboxylic acid) polymer may comprise units with pairs of carboxylic acid groups on adjacent polymer chain carbon atoms. For example such polymers may comprise units:

—[—CR¹R²—CR³R⁴—CR⁵.COOH—CR⁶.COOH—]—

in its structure wherein R¹, R², R³, R⁴, R⁵ and R⁶ are independently hydrogen (preferred) or C₁₋₃ alkyl or C₁₋₃ alkoxy, preferably R¹ and R² being hydrogen, R³ being hydrogen R⁴ being methoxy, and R⁵ and R⁶ being hydrogen, or a derivative thereof retaining COOH groups in its structure, or groups readily hydrolysable to COOH groups. Such a poly-(carboxylic acid) polymer is the polymer based on a copolymer of methyl vinyl ether and maleic anhydride. Such polymers are commercially available under the trade name Gantrez™.

An example of such a polymer comprises:

—[—CH₂—CH.OCH₃—CH.COOH—CH.COOH—]—

units in its structure.

Such polymers may be linear polymers, or cross linked polymers. Linear, non-cross linked, polymers of this type are commercially available under the trade name Gantrez™ S (CAS # 25153-4-69), e.g. Gantrez™ S-96 having a molecular weight ca. 700,000, Gantrez™ S-97 having a molecular weight ca. 1,200,000. Such Gantrez polymers are preferred. In experiments it was found that that a formulation comprising such a Gantrez polymer retained its surface pH of below pH 3.5, suitable to kill viruses, even after 24 hours of immersion in water.

Cross linked polymers of this type are also commercially available under the Gantrez™ trade name.

An example of a derivative of such an acid is an anhydride, i.e. in which the two adjacent —COOH groups are cyclised to form a

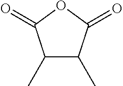

ring system, such an anhydride is susceptible to hydrolysis to form the corresponding free acids. Such polymers are commercially available under the trade name Gantrez™ AN (CAS # 9011-16-9), e.g. Gantrez™ AN-119, Gantrez™ AN-903, Gantrez™ AN-139, Gantrez™ AN-169.

Another example of a derivative is a partial salt, e.g. where some of the free —COOH groups are converted into a metal salt of a Group I or Group II metal such as respectively either sodium or calcium, or a mixed sodium-calcium salt. Such a polymer is commercially available under the trade name Gantrez™ MS, e.g. Gantrez™ MS-955 (CAS # 62386-95-2).

Another example of a derivative of such an acid is a partial ester in which some of the free —COOH groups are esterified with C₁₋₆ alkyl e.g. ethyl or n-butyl. Such polymers are commercially available under the trade name Gantrez™ ES, e.g. Gantrez™ ES-225 (CAS # 25087-06-03) or Gantrez™ ES-425 (CAS # 25119-68-0. Typically polymers of this second type have molecular weights in the range 200,000-2,000,000.

Other poly-(carboxylic acid) polymers of this type include copolymers of C₁₀₋₃₀ alkyl acrylates and one or more monomer compound of formula R⁴R⁵C═CR⁶—COO R⁷, wherein each of R⁴, R⁵, R⁶, and R⁷ is independently selected from hydrogen or C₁₋₅ alkyl, in particular methyl, ethyl or propyl. Examples of such monomer compounds include esters of acrylic acid and methacrylic acid.

Other suitable poly-(carboxylic acid) polymers include anionic polymers based on compounds of formula R₁R₂C═CR₃—COO R₄, wherein each of R₁, R₂, R₃ and R₄ is independently selected from hydrogen or C₁₋₅ alkyl, in particular methyl, ethyl or propyl. Examples of such polymers are those based on methacrylic acid and ethylacrylates with carboxylic acid functional groups available from Rohm GmbH & Co under the trade name “Eudragit”. Specific grades include Eudragit L100-55, L30-D-55, L100, S100 and FS 30D.

Other suitable acidic polymers may be polymers incorporating other acid groups such as sulphonic acid groups. Example of acidic polymers incorporating sulphonic acid groups are co-polymers of an acrylic or methacrylic acid with a sulphonic acid, e.g. linear copolymers. Such polymers incorporating sulphonic acid groups may be used in the form of their salts, e.g. their sodium salts. An example of a copolymer of acrylic acid and sulphonic acid is commercially available under the trade name Good-Rite™ K-776. Other acidic polymers may comprise copolymers of acrylic acid and a sulphonic acid. For example the acidic polymer may comprise copolymers and terpolymers of maleic acid, poly(2-acrylamido-2-methylpropane sulfonic acid) (“polyAMPS”), and copolymers of acrylic acid and 2-acrylamido-2-methylpropane sulfonic acid.

Polystyrene sulphonic acids may be suitable, for example a commercially available polystyrene sulphonic acid in the form of its sodium salt available under the name Flexan™ II with a molecular weight of around 120,000 may be suitable.

Other suitable acidic polymers are believed to include polyvinyl phosphonic acids.

Acidic polymers which have been found useful for the purposes herein have been found to have molecular weights in the range 30,000 to 2,000,000 but molecular weight does not appear to be critical, and this may be simply an exemplary range.

The formulations of this invention may contain one or more acidic polymer.

The coating and impregnation formulations of this invention include one or more surfactant. A surfactant can facilitate wetting of the articles of the invention, and the contact between the coating and impregnation formulation and the article itself. Airborne pathogens such as virus are known to be carried in small droplets of water, and consequently enhanced wetting of the article can enhance the effective contact between the pathogen and the active materials on the article. Furthermore surfactants are known to be effective in disrupting the membranes of virus and bacteria.

Various types of surfactant may be used in the formulations of this invention.

For example a non-ionic surfactant may be used. Examples of non-ionic surfactants are those selected from the Tween™ or Polysorbate™ family (i.e. based on polyoxyethylene sorbitan fatty acid esters such as the monolaurate) of surfactants. Preferred non-ionic surfactants include Tween 20™ and Polysorbate 20™.

For example an ionic, e.g. anionic surfactant may be used. Such surfactants are compounds having a hydrophilic anionic group and an associated cation. Such a cation may be metallic, such as alkali metal, or non-metallic such as ammonium or quaternary ammonium. Typically such anionic surfactants comprise the hydrophilic anionic group and the cation in the form of a salt. Preferably the anionic surfactant comprises a sodium salt of an organic hydrophilic anionic group. Suitably the organic hydrophilic anionic group may be a sulphonic acid or carboxylic acid group.

A preferred such anionic surfactant compound has the formula (I):

CₙH₂ₙ₊₁—Z⁻ M⁺ (I)

where n is 8 to 20, preferably 10 to 15, Z is SO₃ or SO₄, and M is sodium or potassium. A preferred anionic surfactant of this type is sodium lauryl sulphate (n=12, Z is SO₄, M is sodium).

Other anionic surfactants which may be suitable are those of the formula (II):

CₙH₂ₙ₊₁—X—CₘH₂ₘ—Z⁻ M⁺ (II)

where n+m are 8 to 20, X is —O— or —CO.O—, Z is SO₃ or SO₄, and M is sodium or potassium. A preferred anionic surfactant of this type is sodium cocoyl isethionate (n=9, m=2, X is CO.O, Z is SO₃, M is sodium. Another anionic surfactant of formula (II) is sodium laureth sulphate.

Other anionic surfactants which may be suitable are those of the formula (III):

CₙH₂ₙ₊₁—CO.NR.—CₘH₂ₘ—Z⁻ M⁺ (III)

Where n and m are each 1 or more, n+m are 8 to 20 R is C₁₋₃ alkyl, Z is CO.O, SO₃ or SO₄, and M is sodium or potassium. An example of an anionic surfactants of this type is sodium methyl cocoyl taurate (R is methyl, m=2, Z is SO₃, M is sodium).

Other anionic surfactants are olefin sulphonates such as alpha-olefin such as the commercial material Bioterge™ As-40, being the sodium salt of C₁₄₋₁₆ sulphonates.

Other anionic surfactants which may be suitable include sodium methyl lauroyl taurate, sodium methyl stearoyl taurate and sodium methyl palmitoyl taurate (and their analogues of different alkyl chain length), ammonium lauryl sulphate, ammonium laureth sulphate, sodium cocoyl sarcosinate, triethanolamine lauryl sulphate, triethanolamine laureth sulphate, disodium oleamide sulfosuccinate, disodium laureth sulfosuccinate, disodium dioctyl sulfosuccinate. Other classes of anionic surfactants which may be suitable include the alkaryl sulphonates, alkyl succinates, alkyl sulphosuccinates, N-alkoyl sarcosonates, alkyl phosphates, alkyl ether phosphates, alpha-olefin sulphonates and acyl methyl taurates, especially the sodium, magnesium, ammonium and mono-, di- and triethanolamine salts. Alkyl groups in the preceding may contain 8 to 20 carbon atoms. Alkyl ether sulphates and alkyl ether phosphates may contain 1 to 10 ethylene oxide or propylene oxide units per molecule.

One or more surfactant may be used in the formulations of the invention.

The coating and impregnation formulations of the invention include one or more acid. Suitably the one or more acid may be selected from organic carboxylic acids, preferably a solid such acid. Examples of such solid carboxylic acids include: citric, salicylic, fumaric, benzoic, glutaric, lactic, malonic, acetic, glycolic, malic, adipic, succinic, aspartic, phthalic, tartaric, glutamic, pyroglutamic, gluconic acid, and mixtures of two or more thereof.

It is known e.g. from the state of the art reviewed above to use acids such as citric acid as antiviral agents, and the presence of such an acid can enhance the anti-viral activity of the formulation. However it has hithertoo been found difficult to deposit citric acid on articles because of poor adhesion between the citric acid and the substrate. It has advantageously been found that acidic polymers of the type used in the present invention can act to enhance binding of such acids to surfaces.

A preferred combination of acidic polymer, surfactant and acid in the coating and impregnation formulations of this invention is a linear polymer comprising:

—[—CH₂—CH.OCH₃—CH.COOH—CH.COOH—]—

units in its structure, such as Gantrez S97; the non-ionic surfactant Polysorbate 20 or Tween 20 (a polyoxyethylene sorbitan monolaurate), or the anionic surfactant Bioterge As-40 (a water soluble alpha-olefin surfactant which is stable at acid pH) or a combination of a non-ionic surfactant and an ionic surfactant such as a polyoxyethylene sorbitan monolaurate and a water soluble alpha-olefin surfactant; and the acid citric acid.

In the coating and impregnation formulations of this invention a suitable weight:weight ratio of acid polymer:surfactant:acid is in the range 1:0.3-2.5:1-2.

Note that materials such as Gantrez™, Bioterge™, Tween 20™ are often supplied commercially as aqueous solutions e.g. Gantrez™ is supplied as a 13% solution, Bioterge™ as a ca. 40% solution of its active ingredient linear olefin sulfonate, and Tween 20™ as a 10% solution and they may be used in this form in coating formulations. The ratios expressed

The coating and impregnation formulations of this invention may also incorporate one or more antimicrobial compound. Suitable examples of such compounds include sorbic acid, benzoic acid, thymol, antimicrobial oils, quaternary ammonium compounds (e.g. benzalkonium chloride, cetrimide), phenolic compounds (e.g. triclosan, benzoic acid) biguanides (e.g. chlorhexidine, alexidine) and mixtures thereof. A suitable quaternary ammonium compound is Hyamine 3500 NF™, being an n-(C₁₂₋₁₆) alkyl dimethylbenzylammonium chloride.

The coating and impregnation formulations of this invention may also incorporate one or more metal (especially iron or copper) chelating agent, for example EDTA or a salt or derivative thereof. For example Gantrez™ polymers may benefit from the presence of EDTA disodium salt as a stabilizer.

The coating and impregnation formulations of this invention may also incorporate one or more plasticizer. Such a plasticizer may be used to encourage the formation of a film of the acidic polymer on the fibres of the substrate material. In particular a plasticiser material may be useful in combination with the anionic polymers based on compounds of formula R₁R₂C═CR₃—COO R₄, mentioned above, such as the above-mentioned “Eudragit” polymers. Suitable plasticisers include, for example Triacetin (Glycerol triacetate, 1,2,3-Propanetriol triacetate) triethyl citrate, and diethyl or dibutyl phthalate. Certain non-ionic surfactants such as Tween20™ can also act as a plasticizer, for example for the acidic polymer Gantrez™. A proportion of plasticizer, if used, of ca. 1 to 40 wt. %, for example 1 to 20 wt. % of the weight of the acidic polymer appears to be suitable.

The coating and impregnation formulations of this invention may also incorporate one or more plasticizer.

Suitably ca. 10-50 g, e.g. 20-30 g per square metre of the formulations of the invention deposited on a substrate appears to be appropriate.

The above-mentioned processes of the invention are suitably performed by incorporating, e.g. dissolving or suspending, the ingredients of the coating or impregnation formulation, e.g. as described above, in suitable quantities to achieve the above ratios, in a liquid vehicle to thereby form a liquid coating or impregnating formulation, applying this liquid formulation to the article e.g. by dipping, spraying or other conventional means, if necessary allowing any excess liquid formulation to drain from the article, then allowing or causing the liquid vehicle to evaporate to thereby leave the coating or impregnation formulation on the article. Evaporation of the liquid vehicle may be evaporation in the ambient air or in a heated air. A suitable heated air temperature is less than 100° C.

The liquid vehicle may be aqueous, e.g. water or a mixture of water and an alcohol (e.g. methanol, ethanol, propanol), suitably ethanol.

Suitably for example such a liquid coating or impregnating formulation may comprise 1-6 wt %, suitably 2-4 wt %, of the acidic polymer such as Gantrez S-97. Such an acidic polymer may be used in the liquid coating or impregnating formulation in the form of an aqueous solution, e.g. in the form of the above-mentioned commercially available aqueous solution.

Suitably for example such a liquid coating or impregnating formulation may comprise 3-6 wt % of surfactant such as Bioterge AS-40™ or a mixture of surfactants such as Bioterge AS-40™ and Tween 20™. Such surfactant(s) may be used in the liquid coating or impregnating formulation in the form of an aqueous solution, e.g. in the form of the above-mentioned commercially available aqueous solution.

Suitably for example such a liquid coating or impregnating formulation may comprise 2-6 wt % of the acid, such as citric acid.

Suitably for example such a liquid coating or impregnating formulation may contain the other above-mentioned ingredients such as one or more antimicrobial material, preservative, etc. in suitable amounts.

Such liquid coating or impregnating formulations may also contain 0-1 wt % antimicrobial agent such as benzoic acid.

Such liquid coating or impregnating formulations may also contain a chelating agent such as a sodium EDTA salt, typically at 0-0.3 wt %. Such a liquid coating or impregnating formulation may also contain a plasticizer such as Triacetin, typically at 0-2 wt %.

Such liquid coating or impregnating formulations may be suitably made up to 100 wt % with water or an alcohol such as ethanol or a mixture of water and alcohol.

Such liquid coating or impregnating formulations may suitably be adjusted if necessary to pH 2-3 with for example a base or acid such as sodium hydroxide or hydrochloric acid.

Such liquid coating or impregnating formulations can be made in the form of clear solutions.

This liquid coating or impregnating formulation may also be adjusted to a suitable pH if necessary, for example pH 2-3, typically ca. 2.5. For example an acid such as hydrochloric acid, an alkali such as sodium hydroxide, or a buffer such as a citrate e.g. sodium citrate, may be included into the loading solution to achieve such a pH.

A liquid coating or impregnating formulation suitable for use in the process for making the articles of this invention using the processes of this invention is a further aspect of this invention.

The present invention will now be described by way of example only

### 1. FORMULATIONS

Examples of liquid coating or impregnating formulations are given below:

### Formulation 1

| Ingredient | % (w:w) in solution (as is) |
|---|---|
| Gantrez S97, BF (13% soln.) | 46.20 |
| Polysorbate 20, EP | 3.000 |
| Citric acid monohydrate, EP | 3.000 |
| Disodium Edetate EP | 0.015 |
| Sodium hydroxide EP | 0.1992 |
| Water, purified, EP | 47.5858 |
| Totals: | 100.00 |
| pH | 2.4-2.5 |

### Formulation 2

| Ingredient | % (w:w) in solution (as is) |
|---|---|
| Gantrez S97, BF (13% soln.) | 46.20 |
| Polysorbate 20, EP | 3.000 |
| Citric acid monohydrate, EP | 3.000 |
| Versenol 120 (41% active) | 0.250 |
| Chelating agent | |
| Ethanol 95% (un-denatured) EP | 47.55 |
| Totals: | 100.00 |
| pH | 2.5-2.8 |

### Formulation 3

| Ingredient | % (w:w) in solution (as is) |
|---|---|
| Gantrez S97, BF (13% soln.) | 23.10 |
| Citric acid monohydrate, EP | 3.000 |
| Bioterge AS-40 | 3.000 |
| Versenol 120 (41% active) | 0.250 |
| 0.5N HCl | 1.40 |
| Triacetin | 1.500 |
| Ethanol 95% (un-denatured) EP | QS |
| Totals: | 100.00 |
| pH | 2.61 |

### Formulation 4

| Ingredient | % (w:w) in solution (as is) |
|---|---|
| Gantrez S97, BF (13% soln.) | 23.10 |
| Citric acid monohydrate, EP | 2.000 |
| Benzoic acid | 0.250 |
| Bioterge AS-40 | 3.000 |
| Versenol 120 (41% active) | 0.250 |
| Triacetin | 1.500 |
| Ethanol 95% | QS |
| Totals: | 100.00 |
| pH | 2.61 |

TABLE 1
Formulations 5A-5D

| | Formulation Composition, % w/w | | | |
|---|---|---|---|---|
| Ingredient | 5A | 5B | 5C | 5D |
| Bioterge AS-40¹ | 7.50 | 7.50 | 7.50 | 7.50 |
| Citric Acid anhydrous | 5.00 | 5.00 | 5.00 | 3.00 |
| Tween 20³ | 3.00 | 3.00 | 3.00 | 3.00 |
| Gantrez S-97BF (13%)² | 23.10 | 23.10 | 23.10 | 23.10 |
| EDTA Na4 | 0.10 | 0.10 | 0.10 | 0.10 |
| Water | 61.30 | 13.50 | 60.90 | 63.05 |
| Alcohol 95% | 0.00 | 47.55 | 0.00 | 0.00 |
| Hyamine 3500 NF | 0.00 | 0.25 | 0.00 | 0.25 |
| Sorbic Acid | 0.00 | 0.00 | 0.40 | 0.00 |

¹% expressed used as the % of the 40% commercially available solution.
²% expressed used as the % of the 13% commercially available solution.
³Tween ™ is functioning as a plasticizer for the Gantrez ™.

The pH of formulation solutions 5A-5D was adjusted to 2.3. From the table it can be seen that considering Formulation 5A is a “basic” formulation, Formulations B, C and D differ principally in the respective presence of ethanol, sorbic acid and Hyamine.

### 2. Substrates

The formulations 5A-5D were prepared in the form of aqueous solutions and applied on all four substrates as below.
Polyester (represents nonwoven materials/plastics)
Glass (general inert hard surface)
Cotton (laundered T-shirt jersey-represents clothing)
Paper (represents cellulose material)

The solutions 5A, 5C and 5D were soaked through the polyester, paper and cotton substrates and allowed to dry. The solution 5B was applied on the surface of glass at approximately 25 g per square meter of surface area and allowed to dry.

### 3. Activity Testing

The respective substrate coating and tests performed are summarized in Table 2 below.

TABLE 2
Formulations and Testing Matrix

| Surface | 5A | 5B | 5C | 5D | Control |
|---|---|---|---|---|---|
| Polyester | B, C, CA, | NT | B, V, C, | B, V, C, | B, V, C, |
| | pH | | CA, pH | CA. pH | CA, pH |
| Paper | NT | NT | B, V, C, | B, V, C, | B, V, C, |
| | | | CA, | CA, pH | CA, pH |
| Glass | NT | B, V, C, | NT | NT | B, V, C, |
| | | CA, pH | | | CA, pH |
| Cotton | B, V, C, | NT | B, V, C, | B, V, C, | B, V, C, |
| | CA, pH | | CA, pH | CA, pH | CA, pH |

NT = not tested, B = bactericidal efficacy test; V = virucidal efficacy test; C = cytotoxicity test; CA = citric acid assay;

### Bactericidal Efficacy Testing

### 1. Test Microorganisms

Organisms were selected to represent different categories and listed as test organisms in standardized methods. Although Enterococcus hirae (formerly Streptococcus faecalis) was initially suggested in protocol, this organism was replaced with S. mutans since this organism was considered to be tolerant of high acid environment in the mouth and is similar in requirements to E. hirae. Table 3 below lists organisms tested.

TABLE 3
Test Organisms Used to Challenge Samples

| Organism | Category |
|---|---|
| Staphylococcus aureus ATCC 6538 | Gram positive cocci |
| | (catalase positive) |
| Pseudomonas aeruginosa ATCC 9027 | Gram negative non-fermentor |
| Escherichia coli ATCC 8739 | Gram negative fermentor |
| Streptococcus mutans ATCC 25175 | Gram positive cocci in short |
| | chains (catalase negative) |

### 2. Bactericidal Efficacy Test Method

Standard Protocol MD027-10 was used for testing the test surfaces+coating. This protocol was based on the AATCC Test Method 100-2004 Assessment of Antibacterial Finishes on Textile Materials, and was performed by challenging 2.5 cm squares of each sample with 0.1 ml of pH 7 phosphate buffer containing approximately 6 log10 of each inocula tested separately.

After an exposure period of 5 minutes, the activity was stopped by adding the swatches containing surviving organisms to 100 ml neutralizing broth (TSB+0.5% lecithin and 4% tween 80). Survivors were then enumerated by serial 10-fold dilutions and subsequent plating of 1 ml volumes of −2 through −5 dilutions in TSA; followed by incubation in a conventional medium for at least 4 days at 30-35° C. until formation of colonies.

All tests were run in duplicate and survivors from samples were compared to survivors on swatches of the same material without coatings. Log reduction from the control was then calculated; the minimum detection limit being </=2 log10. All fabric samples were tested for bioburden prior to testing.

### 3. Surface Bactericidal Test Results

### Pre-Test Bio-Burden Results

Results displayed in Table 4 below show all test samples except cotton were clean with <100 cfu/2.5 sq. cm; cotton samples showed recoveries of <100 to 1000 cfu/sq. cm. Interestingly, the control sample without coating is showed the highest level of contamination with 1,100 cfu/swatch; the base sample contained 950 cfu/swatch; the sorbic acid sample showed 300 cfu/swatch; and there was no recovery (<100) on the hyamine samples. These test results were not from duplicate samples

TABLE 4
Pre-test Sample Bio-burden Controls

| | | |
|---|---|---|
| | TAMC | TYMC |
| Sample | cfu/swatch | cfu/swatch |

| | | | |
|---|---|---|---|
| Polyester | Formulation 5A | <100 | <100 |
| Polyester | Formulation 5B | <100 | <100 |
| Polyester | Formulation 5C | <100 | <100 |
| P. ester control | | <100 | <100 |
| Paper | Formulation 5C | <100 | <100 |
| Paper | Formulation 5D | <100 | <100 |
| Paper control | | <100 | <100 |
| Glass | Formulation 5B | NT | NT |
| glass control | | NT | NT |
| cotton | Formulation 5A | 950 | <100 |
| cotton | Formulation 5C | 300 | <100 |
| cotton | Formulation 5D | <100 | <100 |
| cotton control | | 1,100 | <100 |

### Surface Bactericidal Efficacy Results

Results displayed in Table 5 below show bactericidal efficacy of all test Formulae applied to polyester, paper, glass, and cotton in the 5 minute time period. The Formulae applied to paper, polyester and glass killed to the detection limit (2 log10) in 5 minutes. The results on cotton, however, showed reduced and/or variable results. Since the cotton also showed the highest bio burden described in Table 4, there is some question as to the handling of sample prior to application of the coatings. It is suggested that these samples in the future be boiled prior to testing to remove any chemical or microbiological contamination.

TABLE 5
Bactericidal Efficacy (Log10 Reduction) on Surfaces

| | | Innocula (log10 test level) | | | |
|---|---|---|---|---|---|
| | | | E. coli | P. | |
| | | S. aureus | (5.5) [6.6 | aeruginosa | S. mutans |
| Surface | Formulation | (6.2) | retest]* | (6.3) | (6.6) |
| Poly- | No coating | 0.0 | 0.0 | 0.1 | 0.0 |
| ester | 5A | >4.2 | >3.5 | >4.4 | >4.6 |
| | 5C | >4.2 | >3.5 | >4.4 | >4.6 |
| | 5D | >4.2 | >3.5 | >4.4 | >4.6 |
| Paper | No coating | 0.5 | 0.3 | 0.3 | 0.3 |
| | 5C | >3.7 | >3.2 | >4.0 | >4.3 |
| | 5D | >3.7 | >3.2 | >4.0 | >4.3 |
| Glass | No coating | 0.1 | 0.1 | −0.2 | −0.1 |
| | 5B | >4.1 | >3.4 | >4.5 | >4.7 |
| Cotton | No coating | 0.2 | 0.2 | 0.1 | 0.1 |
| | 5A | >4.0 | 1.1 | >4.2 | >4.5 |
| | 5C | >3.5 | >1.0 | >4.2 | >3.9 |
| | | | [>4.6] | | |
| | 5D | 3.1 | >1.3 | 1.2 | 3.7 |
| | | | [>1.7] | | |

Data represents average of duplicate tests when absolute numbers are available; otherwise lowest value is reported.
*E. coli was retested as it was initially thought there was a sample mix-up.

### 4. Surface Virucidal Efficacy Testing

### Method and Results

Selected formulations applied on substrate to represent various surfaces were tested for two viruses Influenza type A virus Hong Kong 8/68 and Human Rhinovirus 42. The test was performed at Gibraltar Labs according to standard protocols.

The coated samples and respective controls of 1 inch×1 inch each were subjected to 5 min contact with each of the selected viruses. Every sample, and the respective control uncoated substrate, were tested in duplicate. The final log reduction results were calculated based on calculated Log₁₀ TCID₅₀/mL.

The average results of virucidal efficacy of coated surfaces against respective un-treated control substrates are summarized in Table 6 below.

TABLE 6
Results of Surface Virucidal Efficacy Tests

| | | Antiviral efficacy | | | |
|---|---|---|---|---|---|
| | | | | Influenza A2/Hong | |
| | | Human Rhinovirus 42 | | Kong/8/68 | |
| | Substrate | | Inactivation | | Inactivation |
| Formulation | Material | ΔLog | Percentage | ΔLog | Percentage |
| 5A | Cotton jersey | ≧1.5 | ≧96.83772% | ≧2.4 | 99.60189% |
| 5B | Glass slide | ≧5.9 | ≧99.99987% | ≧2.4 | 99.60189% |
| 5C | Polyester 80 | 0 | ≦68.37722% | ≧3.0 | 99.90000% |
| | grams | | | | |
| 5D | Polyester 80 | 0.8 | 84.15106% | ≧3.0 | 99.90000% |
| | grams | | | | |
| | Cotton jersey | ≧1.7 | ≧98.00474% | ≧2.4 | 99.60189% |
| | Filter paper | ≧1.9 | ≧98.74107% | ≧2.4 | 99.60189% |

All surface substrates coated with all formulations indicated significant surface efficacy against both viruses: RV-42 and HK. The only exception, indicating no surface efficacy against the RV-42, but very significant efficacy against the Influenza virus, was the polyester substrate coated with formulation 5C.

### 5. Cytotoxicity Testing

### Method and Results

All four developed formulations applied on all selected substrate surfaces were evaluated for cytotoxicity at NAMSA Labs based on in-vitro USP, General Chapter <87>, Biological Reactivity Test. All coated samples and control substrates were evaluated against both: positive control Article Latex and negative control article high density polyethylene (HDPE).

Scoring for cytotoxicity was based on the criteria established for conditions of cultures ranging from none, where there was no detectable zone around or under the specimen to severe, where the zone extended more than 10 mm beyond the specimen. The results are summarized in Table 7 below.

TABLE 7
Cytotoxicity Test Results

| | Formu- | Formu- | Formu- | Formu- | |
|---|---|---|---|---|---|
| | lation | lation | lation | lation | |
| Surface | 5A | 5B | 5C | 5D | Control |
| Polyester | Moderate | NT | mild | severe | none |
| Paper | NT | NT | severe | severe | none |
| Glass | NT | moderate | NT | NT | none |
| Cotton | Severe | NT | severe | severe | slight |

NT = not tested

Moderate cytotoxicity was demonstrated for polyester coated with formulation 5A and glass coated with formulation 5B. The uncoated cotton substrate indicated slight cytotoxicity, while each of the other substrates indicated none. For all other substrates coated, respectively, with formulations 5A, C and D, severe toxicity was indicated.

### 6. Citric Acid Assay

### Method and Results

All coated samples and all control substrates except glass were assayed for citric acid content and results are expressed in mg amount of anhydrous citric acid per square cm of the substrate surface.

An established analytical test method developed and validated for citric acid assay, was adapted to assay citric acid in the tested samples and substrates. The sample test area varied due to availability of coated material and controls. The volume of extracting solvent was adjusted accordingly to ensure similar concentration for all samples within the method linear range. The linearity of responses as function of citric acid concentration from 0.08 mg.mL to 0.8 mg.mL was established during method validation. The controls, uncoated substrates of polyester, cotton and paper samples were prepared in two-fold concentrations, respective to coated samples concentrations. Glass substrate was assumed inert and not likely to interfere with the citric acid assay. No extraneous peaks were observed to interfere with chromatographic separation of citric acid under the method conditions.

The polyester, cotton and paper substrates were soaked throughout the materials and dried, while the glass was coated on one side of the surface. The target load was to obtain roughly 25 g of dry coating/square meter of surface. The assay results are summarized in Table 8 below, and indicate uniform coating load on all substrates.

TABLE 8
Citric Acid Assay Results (mg/cm²⁾

| | Formu- | Formu- | Formu- | Formu- | |
|---|---|---|---|---|---|
| | lation | lation | lation | lation | |
| Surface | 5A | 5B | 5C | 5D | Control |
| Polyester | 0.95 | NT | 0.92 | 0.51 | 0.002 |
| | | | | | (<0.3% of 564) |
| Paper | NT | NT | 0.91 | 0.55 | 0.0001 |
| | | | | | (<0.02% of 566 |
| Glass | NT | 0.92 | NT | NT | NT |
| Cotton | 0.93 | NT | 0.89 | 0.65 | 0.00005 |
| | | | | | (0.02% of 565) |

NT = not tested

Based upon this data, the selected Formulations 5A-5D showed bactericidal efficacy when coated on polyester, paper, glass, and cotton. There is some evidence of reduced bactericidal efficacy on cotton jersey; however, this may be due to contamination of the test samples. The selected four substrates coated with four optimized Formulations 5A-5D demonstrated significant efficacy against Type A Influenza Virus Hong Kong 8/68. Further, the selected substrates coated with all four Formulations 5A-5D, except polyester coated with formulation 5C, demonstrated significant efficacy against Human Rhinovirus 42. Inert substrate glass, coated with Formulation 5B demonstrated exceptionally high efficacy against Human Rhinovirus 42. Acceptable cytotoxicity was demonstrated for polyester coated with formulation 5A and glass coated with formulation 5B. Target surface loading of Formulations 5A-5D at approximately 25 g per square meter was achieved on all four selected substrates.

1. A personal protection barrier article comprising a barrier layer which is substantially impermeable to water and/or air, and which is adapted to provide a physical barrier between a human body and an undesirable contact, the barrier layer having on its surface a coating formulation having activity to de-activate pathogenic micro-organisms, the coating comprising an acidic polymer, a surfactant and an acid.

2. An article according to claim 1 wherein the barrier layer is made from material selected from soft and rigid plastics materials, elastomers and metals.

3. An article according to claim 1 wherein the barrier layer is made from glass.

4. An article according to claim 1, comprising human body clothing, head coverings, eye coverings such as spectacles and goggles, gloves, protective shielding equipment, shoes, boots, children's bootees, diapers, condoms, body bags and other containers for corpses.

5. An article of personal clothing comprising a layer of a fabric, the fabric having on its surface a coating formulation having activity to de-activate pathogenic micro-organisms, the coating comprising an acidic polymer, a surfactant and an acid.

6. An article according to claim 5 wherein the fabric from which the article of clothing is made is selected from rayon and nylon.

7. An article according to claim 5 wherein the fabric from which the article of clothing is made is selected from cotton and polyester.

8. An article according to claim 5, being adapted to fit the upper and/or lower torso of the wearer, and/or the wearers arms, legs, hands and feet.

9. An article according to claim 7 being selected from underwear, overwear, leg wear, coats and headgear.

10. An article intended for sequential handling by multiple persons at least one of whom may be potentially contaminated by pathogenic micro-organisms, having on its surface a coating formulation having activity to de-activate pathogenic micro-organisms, the coating comprising an acidic polymer, a surfactant and an acid.

11. An article according to claim 10 selected from mail envelopes and mail wrapping materials, public seats, money (paper and coins), books and CD's available in public libraries, children's toys, culinary articles; telephones, keypads, pens for public use, light switches, door handles, railings, elevator controls, bathroom surfaces, shower curtains, toilet seats, water taps, bathtubs, shower cubicles and sinks in public washrooms, gym equipment, and multiple use linen.

12. A personal care article comprising an absorbent cellulosic substrate impregnated with an impregnation formulation having activity to de-activate pathogenic micro-organisms, the coating comprising an acidic polymer, a surfactant and an acid.

13. An article according to claim 12 selected from paper towels, toilet paper, hand, face and body wipes.

14. An article according to claim 1 wherein the acidic polymer comprises a poly-(carboxylic acid) polymer which comprises units:
—[—CR¹R²—CR³R⁴—CR⁵.COOH—CR⁶.COOH—]—
in its structure wherein R¹, R², R³, R⁴, R⁵ and R⁶ are independently hydrogen or C₁₋₃ alkyl or C₁₋₃ alkoxy, preferably R¹ and R² being hydrogen, R³ being hydrogen, R⁴ being methoxy, and R⁵ and R⁶ being hydrogen, or a derivative thereof retaining COOH groups in its structure, or groups readily hydrolysable to COOH groups.

15. An article according to claim 14 wherein the acidic polymer is selected from Gantrez™ S-96 having a molecular weight ca. 700,000 and Gantrez™ S-97 having a molecular weight ca. 1,200,000.

16. An article according to claim 1 wherein the surfactant comprises a non-ionic surfactant.

17. An article according to claim 1 wherein the surfactant comprises an anionic surfactant.

18. An article according to claim 1 wherein the acid is selected from organic carboxylic acids.

19. An article according to claim 20 wherein the acid is citric acid.

20. An article according to claim 1 wherein the article has 20-30 g m⁻² on its surface or impregnated therein.

21. An article according to claim 1 wherein the weight:weight ratio of acid polymer:surfactant:acid is in the range 1:0.3-2.5:1-2.

22. An article according to claim 1 wherein the formulation includes a plasticizer.

23. An article according to claim 14 wherein the formulation includes a plasticizer which is a non-ionic surfactant.

24. A process for making an article as claimed in claim 1 in which process the surface of the material of the barrier layer is contacted with a fluid loading solution comprising the acidic polymer, the surfactant and the acid in a liquid vehicle, and causing the liquid vehicle to evaporate to thereby deposit the coating formulation.

25. A process for making an article of clothing as claimed in claim 1, in which process the surface of the fabric is contacted with a fluid loading solution comprising the acidic polymer, the surfactant and the acid in a liquid vehicle, and causing the liquid vehicle to evaporate to thereby deposit the coating formulation. Such a process may be performed either prior to or after incorporating the fabric into the article of clothing.

26. A process for making an article as claimed in claim 1 in which process a coating having activity to de-activate pathogenic micro-organisms is deposited upon an article intended for sequential handling by multiple persons, the coating comprising an acidic polymer, a surfactant and the acid, by contacting the surface of the article with a fluid loading solution comprising the acidic polymer, the surfactant and the acid in a liquid vehicle, and causing the liquid vehicle to evaporate.

27. A process for making an article as claimed in claim 12 in which a formulation having activity to de-activate pathogenic micro-organisms is impregnated onto a personal care article comprising an absorbent paper substrate, the formulation having activity to de-activate pathogenic micro-organisms, the impregnation formulation comprising an acidic polymer, a surfactant and an acid in a liquid vehicle.

28. A process according to claim 1 performed by incorporating the ingredients of the coating or impregnation formulation in a liquid vehicle to thereby form a liquid coating or impregnating formulation, applying this liquid formulation to the article, if necessary allowing any excess liquid formulation to drain from the article, then allowing or causing the liquid vehicle to evaporate to thereby leave the coating or impregnation formulation on the article.

29. A process according to claim 1 wherein the liquid vehicle is aqueous.

30. A process according to claim 28 wherein the liquid vehicle comprises a mixture of water and an alcohol.

30. A process according to claim 29 wherein the alcohol is ethanol.

31. A process according to claim 1 wherein the liquid coating or impregnating formulation has a pH 2-3.
